(19) United States
(12) Patent Application Publication
(10) Pub. No.: US 2006/0095903 A1
(43) Pub. Date: May 4, 2006

(54) Upgrading a software component

(76) Inventors: Chee Pin Cheam, Penang (MY); Monal K. Desai, Chandler, AZ (US)

Correspondence Address: TROP PRUNER & HU, PC, 8554 KATY FREEWAY, SUITE 100, HOUSTON, TX, 77024, US

(21) Appl. No.: 10/949,769

(22) Filed: Sep. 25, 2004

(51) Int. Cl. G06F 9/44

(52) U.S. Cl. 717/168

(57) ABSTRACT

In one embodiment, the present invention includes a method of marking a logic component of a system to be updated, caching message information for the logic component in a service module, and dynamically updating the logic component. In such manner, the update may be performed without any downtime or restarting of the system.

### BACKGROUND

The present invention relates to processor-based systems, and more particularly to upgrading software within such a system.

Today, many computer systems, such as desktop personal computers (PCs), notebook PCs, and even mobile devices such as cellular telephones and personal digital assistants (PDAs) can be joined together in a network with other systems, such as server systems, database and storage systems such as storage area networks (SANs) and the like. Many enterprises form networks as a distributed tier of systems. Such systems may include client-side systems, middle-tier systems such as servers, and back-end systems such as control servers, databases and the like.

Distributed systems can be used to provide data and services to a plurality of clients connected to the system with high availability and limited downtime. Such high availability is often achieved by providing redundancy using various nodes of a system, e.g., middle-tier nodes. In such manner, multiple nodes can perform the same services for different clients and, in the case of a failure, a service or process performed on behalf of a client may be transferred from a failed node to an active node.

While such a distributed system provides high availability during normal operation and even during failures, high availability is generally not possible while upgrading software components within the system.

Many major software systems are shipped with software upgrade capabilities. Software component upgrades are typically effected by causing a managed downtime to load the update and allow it to take effect. Other software upgrades require either the impacted hardware or software processes to be restarted for the upgrade to take effect. The downtimes caused by the upgrades are costly and unsuitable for high availability systems.

A need thus exists to improve software updates in a system, such as a distributed system.

### BRIEF DESCRIPTION OF THE DRAWINGS

FIG. 1 is a block diagram of a distributed system in accordance with one embodiment of the present invention.

FIG. 2 is a flow diagram of a method of upgrading a logic component in accordance with one embodiment of the present invention.

FIG. 3 is a flow diagram of a method of upgrading a core component in accordance with one embodiment of the present invention.

FIG. 4 is a flow diagram of a method in accordance with one embodiment of the present invention.

FIG. 5 is a block diagram of a system with which embodiments of the present invention may be used.

### DETAILED DESCRIPTION

Various embodiments of the present invention may provide high availability and online software component upgrade capabilities to mission critical and other software systems. Such systems may be implemented in an N-tier distributed system and may be used to upgrade software on middle-tier nodes of such a system.

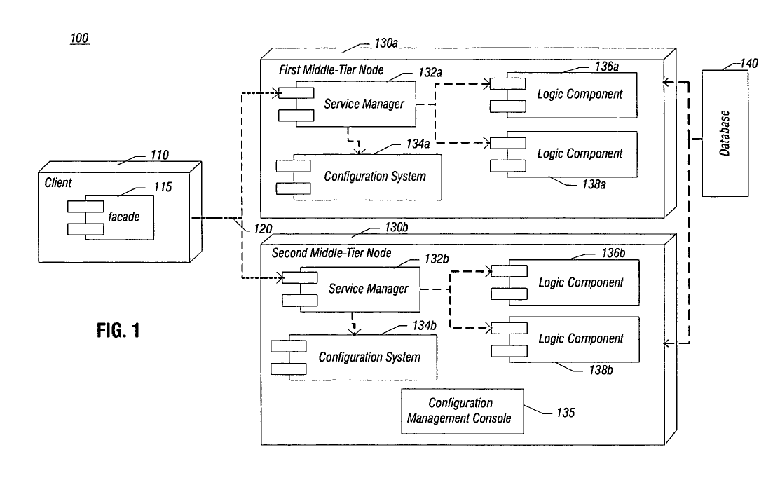

Referring now to FIG. 1, shown is a block diagram of a distributed system in accordance with one embodiment of the present invention. More specifically, FIG. 1 shows an N-tier distributed system 100 that includes a client system 110 coupled to multiple middle-tier nodes, namely a first middle-tier node 130a and a second middle-tier node 130b. Each of the middle-tier nodes may correspond to a server computer or other such system. Such nodes may include an active node and one or more passive nodes. While FIG. 1 shows two middle-tier nodes, many more such nodes may be present in certain embodiments. Further shown in FIG. 1 is a database 140 coupled at a back-end of middle-tier nodes 130a and 130b.

Client 110 may be a PC associated with a user who desires to perform services using distributed system 100. As will be discussed below, client 110 may be a computer within an enterprise that controls or maintains middle-tier nodes 130a and 130b and database 140. Alternately, client 110 may be a system of an independent entity that desires services provided using middle tier nodes 130a and 130b. Client 110 is coupled to middle-tier nodes 130a and 130b via a connection 120, which may be a cluster-enabled connection between client 110 and multiple middle-tier nodes, in certain embodiments. In other embodiments, middle-tier nodes 130a and 130b may be coupled in a load balancing fashion such that multiple clients can access different services or the same services using multiple middle-tier nodes. In such manner, high availability services may be provided to a number of clients while balancing the load created by such usage over a number of different nodes of distributed system 100. In a load balanced environment, all of the nodes may be active at the same time, for example.

As shown in FIG. 1, client 110 may include a façade 115. Facade 115 is a client-side component that may implement retry mechanisms in accordance with an embodiment of the present invention. Such retry mechanisms may be smart and configurable error retry mechanisms to programably handle errors that may occur during transactions between client 110 and a middle-tier node.

As further shown in FIG. 1, each of first and second middle-tier nodes 130a and 130b may include various software modules. Such modules may include a service manager 132a and 132b, a configuration system 134a and 134b and a plurality of logic components, including a first logic component 136a and 136b and a second logic component 138a and 138b. While shown in the embodiment of FIG. 1 as including two different logic components in each node, it is to be understood that the scope of the present invention is not so limited, and different numbers of logic components may be present in different embodiments.

For purposes of discussing the software components within the middle-tier nodes, reference is made to first middle-tier node 130a, although this discussion applies equally to components within second middle-tier node 130b. In one embodiment, service manager 132a may implement remote invocation routing and dispatching based on information specified in configuration system 134a.

FIG. 1 shows a configuration management console 135 in second middle tier node 130b. Configuration management console 135 may be used to perform management operations within distributed system 100. Such management operations may be performed by an information technology (IT) manager or other administrator of distributed system 100. The operations performed using configuration management console 135 may be maintenance measures, upgrading of components within system 100 and the like. While shown in FIG. 1 as being present in second middle-tier node 130b, it is to be understood that configuration management console 135 may be located within any node of distributed system 100. Furthermore, in various embodiments such a console may be provided in multiple nodes within distributed system 100.

As further shown in FIG. 1, distributed system 100 includes a database 140. Database 140 may be coupled to middle-tier nodes 130a and 130b. Database 140 may be a storage area network (SAN), a redundant array of independent disks (RAID) array or other such storage device. Database 140 may be used to store various software components to be used within system 100, and may further include data, such as data of an enterprise that uses distributed system 100. For example, distributed system 100 may be used in a factory environment, such as an assembly, test, and manufacturing (ATM) factory to perform desired services for use in factory operation. In other embodiments, distributed system 100 may be used in a financial services environment, such as a bank or other financial enterprise for use in operations, such as performing and maintaining financial transactions for customers of the enterprise.

Of course, distributed system 100 may be used in any number of other enterprises and it is also to be understood that distributed system 100 may be an Internet-based system to enable multiple unrelated clients to interact with services of an electronic commerce (e-commerce) provider over the Internet. Accordingly, in such embodiments, middle-tier nodes 130a and 130b and database 140 may be hosted by the e-commerce provider, while the client systems are remote users.

During operation, messages from client 110 to request services from a middle-tier node may include a transaction identifier (ID) that identifies the transaction and the service request to be performed. Using this transaction ID, service manager 132a, for example, may forward the request for service to the appropriate logic component, e.g., one of logic components 136a and 138a. Logic components 136a and 138a may implement the actual business logic of the system. For example, such logic may include services requested by a client. Services in a factory environment may include automated activities related to the assembly, test and manufacture of semiconductor devices, for example. In a financial enterprise, services may include the handling of transactions using various accounting, spreadsheet and reporting logic services. Each logic component is hosted with a separate surrogate process to ensure process isolation between the components.

During regular operation, service manager 132a dispatches a call to a desired logic component (e.g., logic component 136a or 138a) based on message payload from client 110 or another such client. For example, service manager 132a may forward message information requesting execution of particular business logic or other logic operations performed by an appropriate one of the logic components present in first middle-tier node 130a.

In certain embodiments, it may be desirable to upgrade software components of various tiers of a distributed system. For example, logic components of middle-tier nodes 130a and 130b may be upgraded to reflect new or revised business logic, processing capabilities and the like.

In one embodiment, a logic component may be upgraded while maintaining system availability and keeping the logic component running on a different node of the distributed system. A logic component upgrade may be effected as follows, in one embodiment. First, the targeted component is marked as “to be upgraded”. This notation may be made in configuration management console 135. Then a corresponding service manager caches messages destined for the targeted component while component upgrade is being performed. The cached messages may be stored in a buffer associated with the service manager in a portion designated for the logic component.

Upon successful completion of the upgrade, the configuration system for the node including the logic component is updated. Specifically, the configuration system may be updated to reflect information regarding the update, such as version, location, and the like. Further, the service manager is notified of the successful upgrade. On indication of a successful upgrade, the service manager may replay cached messages back to the targeted component. Thus in various embodiments the upgrade may take effect immediately, without restarting or rebooting the system.

Facade 115 may implement an error retry mechanism that allows a failed-over situation on a middle-tier system to be transparent to client 110. Thus, software components may be upgraded without taking the system down or restarting or rebooting the system. In such manner, improved system availability and uptime may be realized to keep the system running. Further, built-in system healing capabilities may be enabled by configurable error correction mechanisms, including retry mechanisms. On-the-fly (i.e., dynamic) adding, removing, or modifying of logic components to a distributed system may be effected without impacting an executing client application. In such manner, online logic and/or core component upgrades may occur without system interruption.

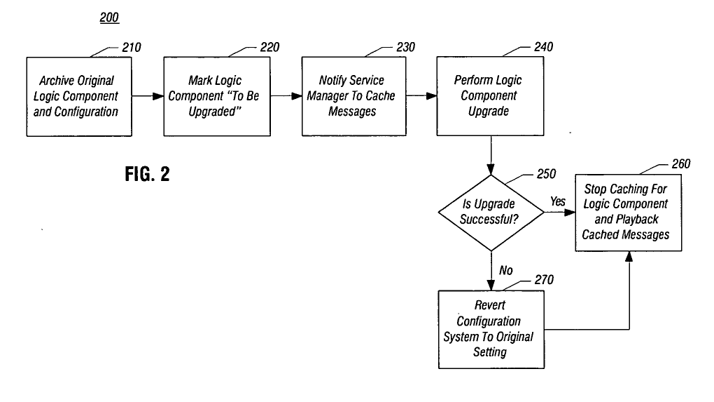

Referring now to FIG. 2, shown is a flow diagram of a method in accordance with one embodiment of the present invention. As shown in FIG. 2, method 200 may be used to upgrade a logic component of a system, for example, a middle-tier node of a distributed system. As shown in FIG. 2, the original logic component and configuration information corresponding thereto may be archived (block 210). For example, in one embodiment the original configuration may be archived in a buffer within the node.

Next, the logic component may be marked with a “to be upgraded” status (block 220). Such a status may be indicated in the configuration system of the node. Then the configuration system may notify a corresponding service manager to cache messages (block 230). More specifically, the service manager may enable a caching mechanism to store message information intended for the targeted logic component. At block 240, the logic component upgrade may be performed. For example, in one embodiment updated code may be loaded into a desired storage of the node. The updated code may be obtained from a remote source, for example, a remote server or other location within a distributed system. For example, in some embodiments as updated code becomes available for distributed system 100, the code may be stored in database 140. Then under control of configuration management console 135, the updated code for a particular node may be downloaded and stored in a storage device of the node, for example, a hard drive or other storage device. Thus the upgraded code may be locally stored within a particular node. However, the upgrade may not take place until a later time, as determined by configuration management console 135. For example, in certain embodiments upgraded code may be downloaded and stored in one or more nodes, but the actual upgrade does not occur until a later predetermined time, such as a given date or upon the occurrence of a given event.

Referring still to FIG. 2, the configuration system may determine whether the upgrade is successful (diamond 250). For example in one embodiment the configuration system may receive a message from the upgraded component, indicating a successful upgrade has occurred. If the configuration system receives such notification, it may notify the service manager of the result.

Accordingly, service manager stops caching messages for the targeted logic component and plays back its cached messages (block 260). Furthermore, the service manager may update its configuration in memory to reflect the upgraded logic component. In such manner, once the update is completed successfully, the newly upgraded component takes effect immediately with no downtime for either the logic component or the system.

If at diamond 250 it is determined that the upgrade was not successful, control may pass to block 270. There, the configuration system may revert back to the original configuration information that was archived at block 210. Accordingly, the original setting for the logic component may be stored in the configuration system (block 270). Furthermore, the service manager may be notified of the result. The service manager may then stop its caching mechanism for the target component and play back cached messages to the original target logic component, as discussed above at block 260.

In various embodiments, core system components may also be upgraded. Such system components may include core code or core software components of systems that form a distributed system. For example, the core code may include code that implements a service manager or a configuration system. Furthermore, such core code may include back-end applications for managing and operating distributed system 100. In certain embodiments, clustering technology may be used to enable system core components to be upgraded with no downtime. At a high level, system core components are upgraded on a passive node of the cluster. When successful, the passive node may be brought online (i.e., activated) by a fail-over mechanism of the clustering technology.

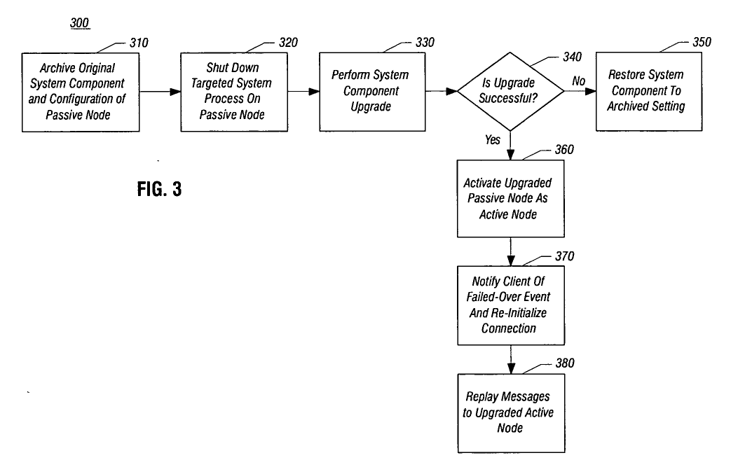

Referring now to FIG. 3, shown is a flow diagram of a method in accordance with one embodiment of the present invention. More specifically, method 300 may be used to upgrade a system core component in a middle-tier node of an N-tier distributed system, such as a server. As shown in FIG. 3, the original system component and its configuration information for a passive node may be archived (block 310). For example, the passive node may be a computer of a cluster-enabled tier of computers. Next, the targeted system process executed by the targeted system component may be shut down on the passive node (block 320). Then system component upgrade may be performed (block 330). The upgrade may be performed under control of a configuration system of the node.

Then it may be determined whether the upgrade occurred successfully (diamond 340). The configuration system may receive an indication of successful completion from the upgraded component, as discussed above. If successful, the upgraded passive node may be activated as the active node of the middle-tier (block 360). That is, the upgraded passive node may be failed-over to be the active node. Thus once the upgrade is completed successfully, the newly upgraded component takes effect immediately with no downtime.

When the fail-over takes place, all in-transit connections and transactions between one or more clients and the previously active node of the middle-tier will fail. Accordingly, on such failures fa525çade 115 of client 110, for example, that loses a connection with the previously active node is notified of the connection failure (block 370). Then, fa525çade 115 may initiate an error retry mechanism to re-establish a connection. Upon the re-established connection, fa525çade 115 may replay its messages back to the service manager of the newly upgraded and active node (block 380). With this mechanism of fa525çade 115, an absolute transparent fail-over mechanism may be implemented on the system with no downtime.

In certain embodiments, such as where multiple middle-tier nodes are present, method 300 may be serially performed on each of the nodes.

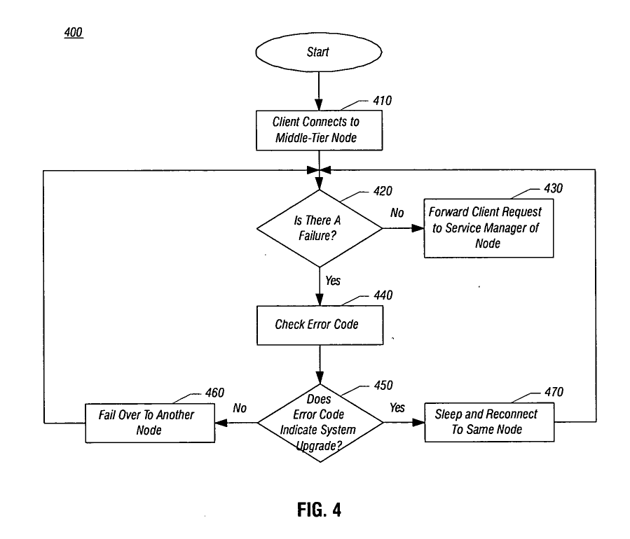

Referring now to FIG. 4, shown is a flow diagram of a method in accordance with one embodiment of the present invention. As shown in FIG. 4, method 400 may be implemented using client-side logic and/or code within one or more nodes of an N-tier distributed system.

As shown in FIG. 4, method 400 may begin by connecting a client to a middle-tier node of the system and providing a client request to the node (block 410). For example, a fa525çade of the client may include code to perform the connection. Then it is determined at diamond 420 if a failure occurs during connection. If there is no such failure, the client request is forwarded to a service manager of the node (block 430). Accordingly, the node performs the service requested by the client.

If instead at diamond 420 it is determined that there is a failure, the error code of the failure is checked (block 440). Such an error code may be transmitted back to the client from an active middle-tier node. Next, the fa525çade or other code within the client may determine whether the error code indicates that a system upgrade is occurring (diamond 450). If such an upgrade is occurring, the client may initiate a sleep cycle and reconnect after a predetermined time period (block 470). Thus, a loop between diamond 420, block 440, diamond 450 and block 470 may be traversed. In such manner, a retry mechanism of the fa525çade is implemented to maintain connection and high availability of the desired logic component during an upgrade process.

If instead at diamond 450 the error code is not indicative of the system upgrade, control may pass to block 460. There, the middle-tier may fail over to another node (block 460). Then control passes again to diamond 420.

In the manner described with respect to method 400, a fa525çade and one or more nodes may work together to perform a desired client service while an upgrade to the logic component that performs the service is occurring on at least one node of the distributed system. The retry mechanism of the client enables on-the-fly or dynamic updating of logic components, core components and the like while maintaining high availability of the distributed system.

Certain embodiments of the present invention may be used as a main architecture design to build a distributed software system with strict availability and mission criticality requirements. For example, an embodiment may be used in a factory environment, such as an ATM unit level tracking (ULT) system, allowing various logic and system components to be updated without any impact on the factory, significantly reducing managed downtime. Various embodiments may be implemented with different software technologies such as COM+, and .NET available from Microsoft Corporation, Redmond, Wash.; JAVA2 Platform, Enterprise Edition (J2EE) available from Sun Microsystems, Santa Clara, Calif.; or Linux Red Hat Package Manager (RPM) technology.

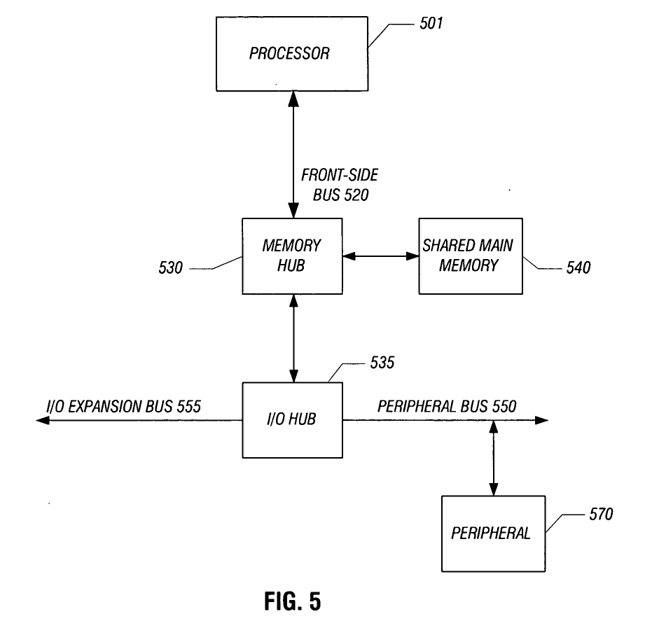

Referring now to FIG. 5, shown is a block diagram of a representative computer system with which embodiments of the invention may be used. As shown in FIG. 5, the computer system includes a processor 501. Processor 501 may be coupled over a front-side bus 520 to a memory hub 530 in one embodiment, which may be coupled to a shared main memory 540 via a memory bus.

Memory hub 530 may also be coupled (via a hub link) to an input/output (I/O) hub 535 that is coupled to an I/O expansion bus 555 and a peripheral bus 550. In various embodiments, I/O expansion bus 555 may be coupled to various I/O devices such as a keyboard and mouse, among other devices. Peripheral bus 550 may be coupled to various components such as peripheral device 570 which may be a memory device such as a flash memory, add-in card, and the like. Although the description makes reference to specific components of system 500, numerous modifications of the illustrated embodiments may be possible.

Embodiments may be implemented in a computer program that may be stored on a storage medium having instructions to program a computer system to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
marking a logic component of a system to be updated;
caching message information for the logic component in a service module; and
dynamically updating the logic component.

2. The method of claim 1, further comprising replaying the cached message information to the logic component.

3. The method of claim 1, wherein the message information comprises a request for a service of the logic component.

4. The method of claim 1, further comprising executing the updated logic component without restarting the system.

5. The method of claim 1, wherein the system comprises a middle-tier node of an N-tier distributed system.

6. The method of claim 5, further comprising clustering the middle-tier node with a plurality of middle-tier systems.

7. The method of claim 1, further comprising updating a configuration module with configuration information regarding the updated logic component.

8. The method of claim 1, further comprising archiving the logic component and corresponding configuration information before updating the logic component.

9. The method of claim 8, further comprising determining if dynamically updating the logic component was successful.

10. The method of claim 9, further comprising reverting to the archived configuration information for the logic component if dynamically updating the logic component was not successful.

11. A method comprising:
archiving a system component of a passive node of a clustered system;
dynamically upgrading the system component; and
activating the passive node to be the active node of the clustered system to cause a pending transaction between a client and the clustered system to fail.

12. The method of claim 11, further comprising notifying the client regarding the failure.

13. The method of claim 11, further comprising establishing a new connection between the client and the clustered system and replaying message information regarding the pending transaction to the clustered system.

14. The method of claim 13, further comprising executing the pending transaction using the upgraded system component.

15. The method of claim 11, further comprising upgrading a corresponding system component of other nodes of the clustered system.

16. The method of claim 11, wherein dynamically upgrading the system component comprises upgrading the system component on-the-fly without restarting the passive node.

17. An article comprising a machine-accessible storage medium containing instructions that if executed enable a system to:
mark a logic component of a system to be updated;
cache message information for the logic component in a service module; and
dynamically update the logic component.

18. The article of claim 17, further comprising instructions that if executed enable the system to replay the cached message information to the logic component.

19. The article of claim 17, further comprising instructions that if executed enable the system to update a configuration module with configuration information regarding the updated logic component.

20. The article of claim 17, further comprising instructions that if executed enable the system to archive the logic component before updating the logic component.

21. A system comprising:
a processor;
a dynamic random access memory containing instructions that if executed enable the system to replay at least one transaction message to a node of a distributed system if the system receives an indication that the at least one transaction message failed; and
a communication interface to receive the indication.

22. The system of claim 21, further comprising a fa525çade to perform a retry mechanism if the indication is indicative of an upgrade of a component related to the at least one message transaction within the distributed system.

23. The system of claim 22, wherein the fa525çade to perform the retry mechanism after a sleep interval.

24. The system of claim 21, wherein the system comprises a client system coupled to the distributed system, the distributed system having a plurality of middle-tier nodes.
